(19) United States
(12) Patent Application Publication
(10) Pub. No.: US 2006/0117256 A1
(43) Pub. Date: Jun. 1, 2006

(54) Method of operating a web

(76) Inventors: Steven Henry Miller, Castle Rock, CO (US); Christopher Steven Miller, Parker, CO (US); Jeffrey Donald Pullara, Castle Rock, CO (US); Julie Ann Zimmerman, Castle Rock, CO (US); Willimiam John McAndrews Boyd, Castle Rock, CO (US); Paul Kenneth Zorn, Littleton, CO (US); Ernest Marion Duckworth III, Littleton, CO (US)

Correspondence Address: LAW OFFICE OF DALE B. HALLING, LLC, 655 SOUTHPOINTE COURT, SUITE 100, COLORADO SPRINGS, CO, 80906, US

(21) Appl. No.: 11/263,565

(22) Filed: Oct. 31, 2005

Related U.S. Application Data
(63) Continuation-in-part of application No. 10/902,613, filed on Jul. 29, 2004.
(60) Provisional application No. 60/623,930, filed on Nov. 1, 2004.

(51) Int. Cl. G06F 17/24

(52) U.S. Cl. 715/530

(57) ABSTRACT

A method of operating a web page includes the steps of displaying an article having an iframe on a web client. A website is inserted in the iframe.

### RELATED APPLICATIONS

The present invention claims priority on provisional patent application, Serial No. 60/623,930, filed on Nov. 1, 2004, entitled “Embedded Website” and is hereby incorporated by reference. This patent application is a continuation-in-part of U.S. patent application, Ser. No. 10/902,613, entitled “Content delivery and storage system and method” filed on Jul. 29, 2004, and hereby incorporated by reference.

### FIELD OF THE INVENTION

The present invention relates generally to the field of the internet and more particularly to a method of operating a web page.

### BACKGROUND OF THE INVENTION

Advertisers have been excited by the possibilities of the World Wide Web or more generally the Internet. Potentially, the Internet allows producers to inexpensively get their message out to a targeted audience. Unfortunately, pop-up advertisements and email advertisements have flooded the Internet in a very indiscriminate fashion. As a result, most consumers have learned to ignore almost all advertising on the Internet. This has effected even more traditional advertisements on home pages.

In the field of internet advertising it is important to obtain as many hits and viewers of your website as possible. This increases your websites placement on search engines and other web ranking devices.

Thus there exists a need for a method of operating a web page that provides a more effective and targeted method of advertising over the Internet and increases the number viewers of your website.

### SUMMARY OF INVENTION

A method of operating a web page that overcomes these and other problems includes the steps of displaying an article having an iframe on a web client. A website is inserted in the iframe. The website that is associated with the article is purposely selected. The website may be a company website and the article is sponsored by the company. An active scroll bar is displayed for the website in the iframe. A user may be able to navigate in the website. A link may be provided that when activated launches the website in a separate window.

In one embodiment, a content delivery and storage system includes an advertising delivery system transmitting an information advertisement to an external web page. The informational advertisement has a hyperlink. A third party marketing validation website with a web page is coupled to the hyperlink. The web page contains a traditional advertisement and an associated website displayed with the web page. The associated website may be owned by a company advertising in the information advertisement. The website may be displayed in an iframe. The website may have an active scroll bar. A user may navigated the website. A link in the web page may be provided that when activated launches the website in a separate window. The traditional advertisement may include a second hyperlink to an advertiser's website.

In one embodiment, a content delivery and storage method, includes the steps of placing an information advertisement on an external website. The informational advertisement has a hyperlink. When the hyperlink is activated, a web page article of a third party is displayed on a marketing validation website. A website is displayed in the web page article. The website is selected that is associated with the web page article. A traditional advertisement containing a second hyperlink may be placed in the web page article. The website may be a company website and the web page article is sponsored by the company.

### BRIEF DESCRIPTION OF THE DRAWINGS

FIG. 1 is a block diagram of a content delivery and storage system in accordance with one embodiment of the invention;

FIG. 2 is a block diagram of a content delivery and storage system in accordance with one embodiment of the invention;

FIG. 3 is a block diagram of a third party marketing validation website and content source in accordance with one embodiment of the invention;

FIG. 4 is a flow chart of the steps used in a content delivery and storage system in accordance with one embodiment of the invention;

FIG. 5 is an example of web page containing a website in accordance with one embodiment of the invention; and

FIG. 6 is a flow chart of the steps used in a method of operating a web page.

### DETAILED DESCRIPTION OF THE DRAWINGS

In order to understand the foregoing description and claims the definitions of the following words must be known. As a result, these definitions are provided to help the readers' understanding and to clarify the meaning of these terms as used herein.

### DEFINITIONS

Third party marketing validation website: is a website that is independent of the entity advertising in the advertisement and provides content that is not an advertisement.

Content definition: is a broad category of content such as press releases, editorials, job posting and resumes, etc.

Predefined interval: is between 1 second and 1 hour, in one embodiment it is every 6 seconds.

Hyperlink: is an electronic link to another electronic source of information.

Information advertisement: is an advertisement for more information.

Traditional advertisement: is an advertisement for a purchase of a product or service and usually contains items such a price. It is commonly a request for an offer for sale. It may also be a call button, a lead capture, web show etc.

Second hyperlink: is just a way of distinguishing two different hyperlinks.

External website: is a website that is not part of the third party marketing validation website or the advertiser's website.

Informational content: This is content such as an article that provides information of general interest to the reader as opposed to purchasing information such as price, product specification, ordering or purchasing information. Examples of information content are newspaper articles (electronic or paper), press releases and editorials.

### SYSTEM DESCRIPTION

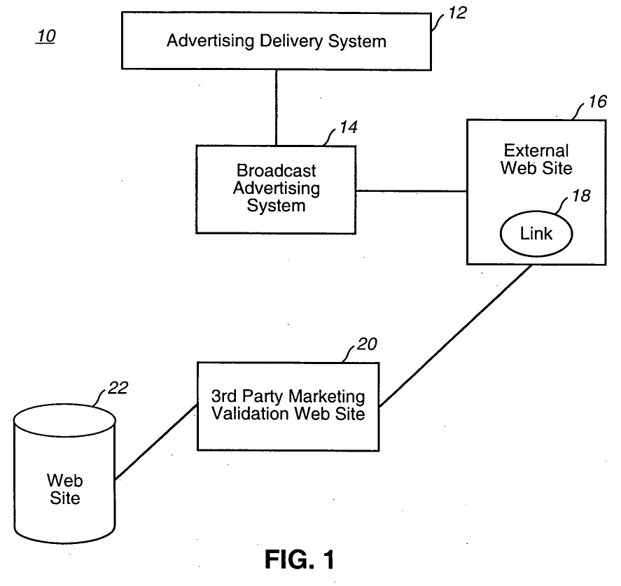

FIG. 1 is a block diagram of a content delivery and storage system 10 in accordance with one embodiment of the invention. The system 10 has an advertising delivery system 12 that transmits an advertisement to a broadcast system 14. The broadcast advertising system 14 transmits the advertisement to an external website 16. Generally, the broadcast advertising system 14 transmits the advertisement to numerous external websites 16. In one embodiment, the advertisement is an information advertisement. An information advertisement entices the reader to ask for more information about a company or product, it does not ask the reader to buy anything. In one embodiment the information advertisements include a header or footer that represents the advertisement as an informational advertisement. The advertisement may be a pop under advertisement, a banner advertisement, a column advertisement or any other advertisement used with websites. The advertisement includes a hyperlink 18 to a third party marketing validation website 20. A third party marketing validation website 20 is a website that is not controlled by the advertiser. A third party marketing validation website 20 is a website that provides information content. The hyperlink 18 connects the viewer with informational content such as an article on the subject. An example of an information advertisement might state “click here to read about how brand X SUV (Sports Utility Vehicle) performed on a recent trip to Moab Utah”. When the user clicked on the hyperlink 18 in information advertisement, the user would be taken to an article or editorial at the third party marketing validation website 20. The article would then describe how brand X SUV performed on the trip to Moab Utah: The third party marketing validation website 20 holds information content, so it is similar to Yahoo or a newspaper's website. As a result, the reader (viewer) trusts the information more than a traditional advertisement. It is an independent third party provider of information that as a result validates the marketing information in the article. The third party marketing validation website 20 is coupled to an advertiser's website 22. As will be apparent to those skilled in the art, the website 22 will commonly be coupled through the internet to the third party marketing validation website 20. When the associated informational content or article is displayed on the third party marketing validation website 20, an iframe is inserted into the article. The iframe contains the advertiser's website 22. The website 22 in the article is fully functional and has a scroll bar to scroll through the website 22. The user may click on links or perform any other function in the website that they could normally perform on the website. By displaying the advertiser's website in the article a visitor does not have to click on that advertisement to visit the website of the company and the company does not have to wait for the visitor to click on its advertisement to gain traffic. The company's website experiences immediate traffic to their website while the visitor is reading the article.

Advertiser's want third party market validation for their products. Third party validation is more effective and credible than traditional advertisements. No previous systems have been designed to allow an advertiser to purposely setup a third party market validation over the Internet.

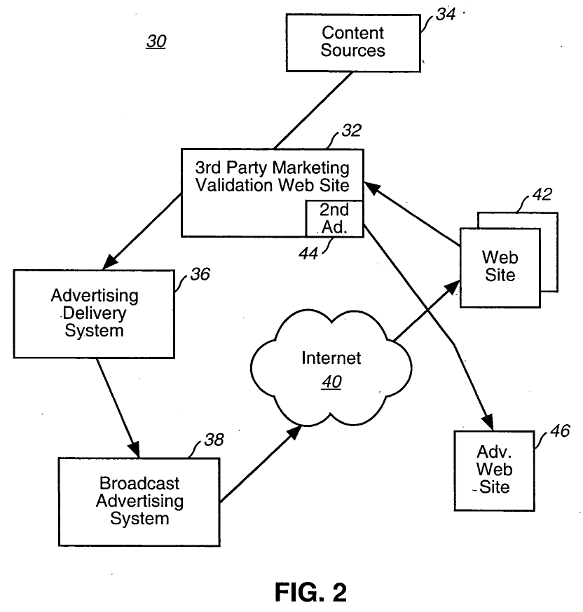

FIG. 2 is a block diagram of a content delivery and storage system 30 in accordance with one embodiment of the invention. The system 30 has a third party marketing validation website 32 coupled to a number of content sources 34. The third party marketing validation website 32 aggregates content from a plurality of content source 34. The third party marketing validation website 32 then hosts this information for users (browsers). As a result, the third party marketing validation website 32 is an informational website and is viewed by readers as an independent provider of information. By independent it is meant that the website does not just contain advertisements or the equivalent of infomercials. The third party marketing validation website 32 is coupled to an advertising delivery system 36. The advertising delivery system 36 is just a system to deliver advertisements to a broadcast advertising system 38 from the creator of the advertisement. In one embodiment, the broadcast advertising system 38 and the advertising delivery system 36 may be one and the same. An example of a broadcast advertising system is Value Click. The broadcast advertising system 38 is connected to the Internet 40. Note that the connections between all the blocks may be through the Internet 40. The broadcast advertising system 38 transmits advertisements to external websites 42. An information advertisement on the external websites 42 has a hyperlink to the third party marketing validation website 32. The hyperlink will cause a posting of content to be displayed on a user's computer screen. Along with the posting of content may be a traditional advertisement 44. The owner of the information advertisement displayed on the external website may be the same as the owner of the traditional advertisement. The traditional advertisement 44 may contain a hyperlink to the advertiser's website 46. In one embodiment, the advertiser's website 46 appears in the content or article on the third party marketing validation website 32. The website in the article is completely functional and the article may contain a button which causes the advertiser's website 46 to appear in another window.

This system 30 allows an advertiser to have multiple points of contact with the consumer before the consumer is asked to purchase a product or service. The first contact is the information advertisement on the external website 42. The next point of contact may be the posting of content such as an editorial or press release on the third party marketing validation website 32. Along with the posting of content may be a traditional advertisement. The traditional advertisement on the third party marketing validation website 32 is the third point of contact with the consumer. If the consumer then visits the advertiser's website 46, this is the fourth point of contact. As a result, the consumer is usually ready to buy when they visit the advertiser's website, store or call center. In addition, the consumer has first been provided relevant information content before they are asked to purchase anything. This enforces the feeling that the advertiser's products or services really meet the consumer's needs. The system 30 provides a more effective and targeted method of advertising over the Internet.

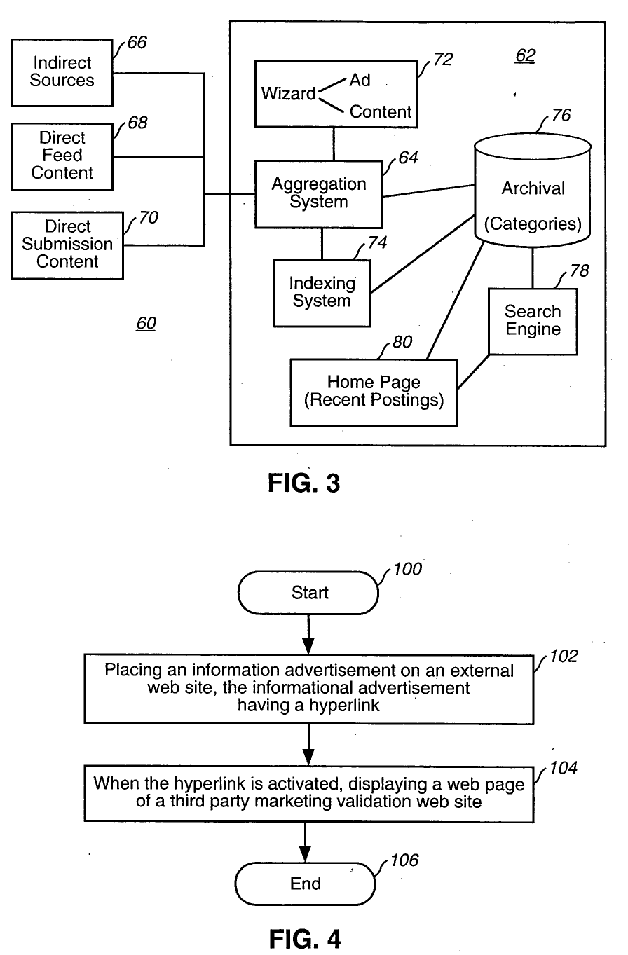

FIG. 3 is a block diagram of a third party marketing validation website and content source 60 in accordance with one embodiment of the invention. The third party marketing validation website 62 has an aggregation system 64 that interfaces with a number of sources of content. One source of content is indirect sources 66. An indirect source 66 is a source from which the aggregation system 64 pulls postings of content that meet a content definition into the third party marketing validation website 62. The content definition may be press releases, editorials, sports, career information, etc. Another source of content is direct feed content 68. Direct feed content is content directly from the creator and is usually an organization that creates content meeting the content definition regularly. For instance, a government organization may regularly issue press releases. A third source of content is direct submission content 70. Direct submission content 70 is content that is pushed into the third party marketing validation website 62 by a source that infrequently has content postings. For instance, a start-up company may only occasionally issue press releases. When a posting is received from a direct submission content provider, the provider is contacted independent of the submission to verify that the author of the posting is authentic. A wizard 72 helps a direct submission content provider to create content that is appropriate and meets their goals. The wizard 72 may also be used to create an information content advertisement.

Once the postings of content are received they may be indexed by an indexing system 74. In addition, the content may be placed in categories. For instance, press releases may be categorized into government, technology, automotive, etc. The posting of content are also archived by an archiving system 76. They may be archived by categories. In one embodiment, the postings are archived permanently. This allows the information in the postings to be searched for research projects. As a result, the archival system 76 is coupled to a search engine 78. The search engine 78 includes a system for skipping to the 10^{th}, 100^{th}, 1000th , etc posting. This is unique, in that most systems allow you to skip to the next page but not to a certain listing. This increases the usefulness of the search results. The archival system 76 is also coupled to a home page 80 of third party marketing validation website 62. The home page 80 is organized to show the most recent posting of content by category. The most recent posting are updated periodically. For instance, in one embodiment they are updated every six seconds. Continuous updating requires multiple feeds to create the home page and may result in slower display of the home page.

FIG. 4 is a flow chart of the steps used in a content delivery and storage system in accordance with one embodiment of the invention. The process starts, step 100, by placing an information advertisement on an external website at step 102. The information advertisement has a hyperlink. When the hyperlink is activated at step 104, a web page of a third party marketing validation website is displayed which ends the process at step 106. A traditional advertisement may be placed in the web page that contains a second hyperlink. When the second hyperlink is activated, an advertiser's website is displayed. A number of postings of content meeting a content definition from a number of sources are aggregated. Every word of the posting of content may be indexed.

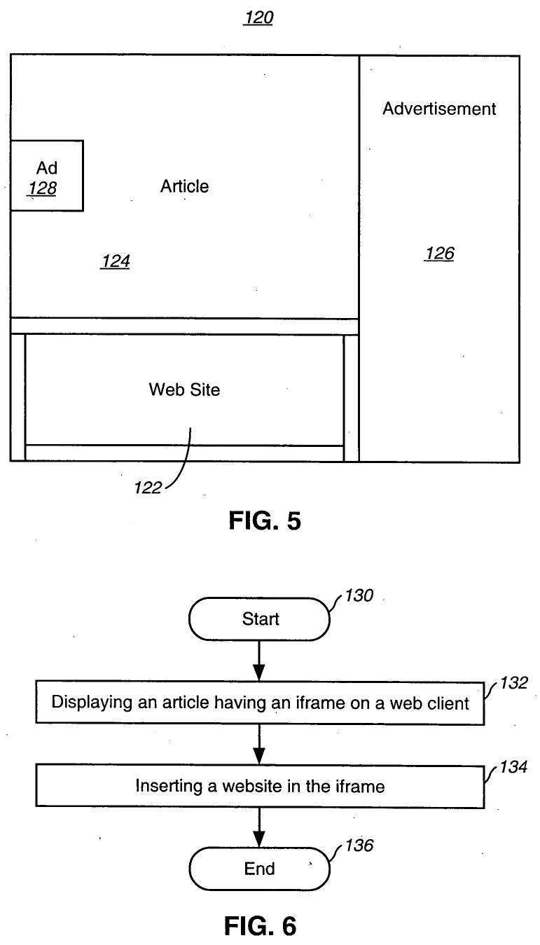

FIG. 5 is an example of web page 120 containing a website 122 in accordance with one embodiment of the invention. The web page 120 may be the article displayed on the third party marketing validation website. The web page 120 includes an article 124 in which a standard electronic advertisement may be inserted. On the right side is a column of advertisements 126. An additional advertisement 128 may be inserted into the article 124 on the left side of the page. The column of advertisements may contain a thumbnail of a website. The thumbnail may be of an advertiser's website. At the bottom or somewhere in the article 124 is the advertiser's website 122. The website 122 is inserted using an iframe and embedding the HTML (Hyper Text Mark-up Language) code that includes the URL (Universal Resource Locator) of the website embedded in the frame. When the website loads within the frame the visitor is able to navigate within the website without leaving the article being viewed. Any traffic directed to the article will also appear in the server logs of the website.

FIG. 6 is a flow chart of the steps used in a method of operating a web page. The process starts, step 130, by displaying an article having an iframe on a web client at step 132. At step 134, a website is inserted into the iframe which ends the process at step 136.

A window is created within the article using Internet technology that enables the website to appear within the window, including a scroll bar for navigating beyond the length of the window. In addition, a visitor can click on a link to launch the entire website into a new window as a full-page view or on a thumbnail picture of the company website as an additional advertisement. Any other articles submitted by the company or individual are linked on the side of the article for additional exposure for the company. This is in addition to standard display advertisements within the article to create an article that turbo-charges the company brand.

Each article includes two display ads, which are provided by the client or created by the third party marketing validation website company for the client. The client can supply ready made advertisements or may use the third party marketing validation website company's automatic ad-creation tools. A thumbnail of the company website is created by the third party marketing validation website company as a graphical image with a hotlink to the company website.

The window where the website is loaded is created using an iFrame and embedding the HTML code that includes the URL of the website that will be embedded into the frame for navigation. When the website loads within the frame the visitor is able to navigate within the website without leaving the article being viewed. Any traffic directed to the article will also appear in the server logs of the website.

By embedding the website into the article a visitor doesn't have to click on the ad to visit the website and a company doesn't have to wait for the visitor to click on its ad to gain the traffic. The company's website experiences immediate traffic to their website while the visitor is reading the article. The combination of multiple ad units with the embedded website creates a new product using multiple points of contact for the company. This becomes part of a complete sales process and goes beyond a traditional advertising unit by enhancing the experience of viewing a powerfully “branded” online article.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of operating a web page, comprising the steps of:
a) displaying an article having an iframe on a web client; and
b) inserting a website in the iframe.

2. The method of claim 1, wherein step (b) includes the step of:
b1) selecting the website that is associated with the article.

3. The method of claim 2, wherein the website is a company website and the article is sponsored by the company.

4. The method of claim 1, wherein step (b) further includes the step of:
b1) displaying an active scroll bar for the website in the iframe.

5. The method of claim 1, wherein step (b) further includes the step of:
b1) allowing a user to navigate in the website.

6. The method of claim 1, further including the step of:
c) providing a link that when activated launches the website in a separate window.

7. A content delivery and storage system, comprising:
an advertising delivery system transmitting an information advertisement to an external web page, the informational advertisement having a hyperlink;
a third party marketing validation website with a web page coupled to the hyperlink, the web page containing a traditional advertisement and an associated website displayed with the web page.

8. The system of claim 7, wherein the associated website is owned by a company advertising in the information advertisement.

9. The system of claim 8, wherein the website is displayed in an iframe.

10. The system of claim 9, wherein the website has an active scroll bar.

11. The system of claim 10, wherein a user can navigated the website.

12. The system of claim 11, further including a link in the web page that when activated launches the website in a separate window.

13. The system of claim 12, wherein the traditional advertisement includes a second hyperlink to an advertiser's website.

14. A content delivery and storage method, comprising the steps of:
a) placing an information advertisement on an external website, the informational advertisement having a hyperlink;
b) when the hyperlink is activated, displaying a web page article of a third party marketing validation website; and
c) inserting a website in the web page article.

15. The method of claim 14, wherein step (c) includes the step of:
c1) selecting the website that is associated with the web page article.

16. The method of claim 14, further including the step of:
d) placing a traditional advertisement in the web page article containing a second hyperlink.

17. The method of claim 16, wherein the website is a company website and the web page article is sponsored by the company.
